SEQUENCE LISTING (2 sequences)

SEQ ID NO: 1 - DNA, 11 bp, ARTIFICIAL
  Example Sequence
gcctatcgcga

SEQ ID NO: 2 - DNA, 8 bp, ARTIFICIAL
  Example Sequence
gcctatcg

(19) United States
(12) Patent Application Publication
(10) Pub. No.: US 2009/0121133 A1
(43) Pub. Date: May 14, 2009

(54) IDENTIFICATION OF NUCLEIC ACIDS USING INELASTIC/ELASTIC ELECTRON TUNNELING SPECTROSCOPY

(75) Inventor: Babak AMIRPARVIZ, Seattle, WA (US)

Correspondence Address: NIXON PEABODY LLP - PATENT GROUP, 1100 CLINTON SQUARE, ROCHESTER, NY, 14604, US

(73) Assignee: UNIVERSITY OF WASHINGTON, Seattle, WA (US)

(21) Appl. No.: 11/939,927

(22) Filed: Nov. 14, 2007

(51) Int. Cl. G01N 23/00

(52) U.S. Cl. 250/310

(57) ABSTRACT

The present invention relates to a method for identifying a nucleotide in a nucleic acid including stretching a nucleic acid to an extended conformation, subjecting a nucleotide of the stretched nucleic acid to electron tunneling spectroscopy, and obtaining a current-voltage curve or a current derivative-voltage curve as a result of the stretching to provide a resonance signature of the nucleotide in the nucleic acid. The present invention also relates to a method for sequencing a nucleic acid. The method includes stretching a nucleic acid to an extended conformation, the nucleic acid including a plurality of nucleotides, subjecting each nucleotide of the stretched nucleic acid to electron tunneling spectroscopy, and obtaining a current-voltage curve or a current derivative-voltage curve as a result of said subjecting to provide a resonance signature of each nucleotide in the stretched nucleic acid.

### FIELD OF THE INVENTION

The present invention relates to a method for identifying a nucleotide in a nucleic acid including stretching a nucleic acid to an extended conformation, subjecting a nucleotide of the stretched nucleic acid to electron tunneling spectroscopy, and obtaining a current-voltage curve or a current derivative-voltage curve as a result of the stretching to provide a resonance signature of the nucleotide in the nucleic acid. The present invention also relates to a method for sequencing a nucleic acid.

### BACKGROUND OF THE INVENTION

Genomic information has assumed a central role in the way biology in general and cell function in particular are understood today. Methods that can sequence DNA rapidly, accurately, and cost-effectively are needed in order to expand our knowledge of the core biology and realize the promise of genomics in areas such as personalized medicine.

DNA sequencing methods in use today, while substantially faster and less expensive than older technology, still rely on some of the earliest developed techniques to sequence DNA (Metzker, “Emerging Technologies in DNA Sequencing,” Genome Res. 15:1767-1776 (2005)). In particular, the chain termination method, also known as Sanger sequencing, is commonly used today and suffers from substantial limitations including an average read length of only 805 bases.

The direct and fast analysis of single macromolecular chains at the level of their primary chemical structure, such as the nucleotide sequence in DNA, poses both a challenge and a great opportunity for life sciences. With respect to DNA, a method for direct sequencing would open new opportunities for mapping the human genome and for developing personalized medicine. Various nano-scale scanning methods, including scanning tunneling microscopy (STM) (Ohshiro et al., “Complementary Base-Pair-Facilitated Electron Tunneling for Electrically Pinpointing Complementary Nucleobases,” Proc. Natl. Acad. Sci. USA, 103:10-14 (2006)), atomic force microscopy (AFM) (Woolley et al., “Deposition and Characterization of Extended Single-Stranded DNA Molecules on Surfaces,” Nano Letters, 1:345-348 (2001)) and their associated techniques are approaching the resolution required for the direct recognition of single bases. In a representative approach, the inelastic electron tunneling current through bases is proposed for determination of the DNA base type (Zhu et al., “Single Molecule DNA Sequencing with Inelastic Tunneling Spectroscopy STM,” T-11 Condensed Matter and Theoretical Physics, Research Highlights 2006, Los Alamos National Laboratory, pp. 83-84 (2006); Clark et al., “Inelastic Electron Tunneling Spectroscopy of Nucleic Acid Derivatives,” Proc. Natl. Acad. Sci. U.S.A., 73:1598-1602 (1976)). However, none of the above methods have been able to demonstrate sequencing of DNA at the single base-pair level. A successful electronic method for detection of DNA may require experiments to be performed at low temperatures reaching the cryogenic levels. This requirement is fundamentally incompatible with all the methods that rely on physical motion of DNA in a solution such as a buffer. A successful DNA sequencing method using STM also requires the extension of single-stranded DNA molecules on a surface and the engineering of the force holding the molecule down during sequencing in order to prevent extra motions of DNA on the surface.

The present invention is directed to overcoming these and other deficiencies in the art.

### SUMMARY OF THE INVENTION

The present invention relates to a method for identifying a nucleotide in a nucleic acid including stretching a nucleic acid to an extended conformation, subjecting a nucleotide of the stretched nucleic acid to electron tunneling spectroscopy, and obtaining a current-voltage curve or a current derivative-voltage curve as a result of the stretching to provide a resonance signature of the nucleotide in the nucleic acid.

The present invention also relates to a method for sequencing a nucleic acid. The method includes stretching a nucleic acid to an extended conformation, the nucleic acid including a plurality of nucleotides, subjecting each nucleotide of the stretched nucleic acid to electron tunneling spectroscopy, and obtaining a current-voltage curve or a current derivative-voltage curve as a result of said subjecting to provide a resonance signature of each nucleotide in the stretched nucleic acid.

The present invention discloses electronic methods that have the capacity to directly read bases without any chemical manipulation or labeling of DNA. Thus, the present invention avoids the limitations of other sequencing methods by directly identifying the individual bases on a single strand of DNA (no PCR is necessary). Because each base is identified directly, there is no need for fluorescent dies or other labeling techniques. Moreover, the methods of the present invention can be performed on very long nucleic acid strands (thousands to millions of bases). The methods consist of stretching a nucleic acid on a conductive substrate (or first electrode), wherein the stretched nucleic acid can then be analyzed using inelastic electron tunneling spectroscopy (IETS) or elastic electron tunneling spectroscopy. The methods of the present invention allow for stretching long viral DNAs on a surface of a first electrode in a controllable fashion making them available for further electronic analysis with STM, which may result in an ultra-low cost and high speed electronic DNA sequencing technique. The methods can be parallelized by using a multiple probe system and can be very fast depending on the STM system and algorithms used.

### BRIEF DESCRIPTION OF THE DRAWINGS

FIG. 1A is a schematic illustration of the procedure for stretching DNA on conductive surfaces by molecular combing. FIG. 1B shows stretching of DNA on an atomically flat gold substrate treated to produce positively charged groups on its surface.

FIG. 2 is a schematic illustration of a method for determining a nucleotide in a DNA molecule immobilized on a conductive substrate (first electrode) which includes a conductive tip (second electrode) close to the surface to perform electron tunneling spectroscopy measurements.

FIG. 3 shows high resolution STM (FIG. 3A), AFM (FIG. 3B), and STM section analysis (FIG. 3C) images of λ phage ds-DNA strands completely elongated on highly ordered pyrolytic graphite (“HOPG”) with molecular combing. The STM scans were performed under V_{bias}=0.3 V and I_{bias}=40 pA. The DNA goes over multiple domains on the graphite surface. The arrows point to the location of the DNA strand.

FIG. 4 shows high resolution STM (FIGS. 4A and B) and AFM (FIG. 4C) images of λ phage ss-DNA strands completely elongated on HOPG with molecular combing. The STM scans were performed under V_{bias}=0.3 V and I_{bias}=40 pA. The arrows point to the location of DNA in the STM image.

FIG. 5 shows STM (FIGS. 5A and B) and AFM (FIG. 5C) images of extended ds-DNA on Au(111) with self-assembling molecular monolayers (“SAM”) containing 1 mol % amine groups. The STM scans were performed at V_{bias}=0.5 V and I_{bias}=30 pA. The DNA molecule appears as a dark line in FIGS. 5A and 5B. The arrows point to the DNA molecules.

FIG. 6 shows STM (FIGS. 6A and B) and AFM (FIG. 6C) images of extended ss-DNA on Au(111) with mixed SAM containing 1 mol % amine groups. The STMs were performed at V_{bias}=1 V and I_{bias}=30 pA. The DNA molecule appears as a dark line in STM in FIGS. 6A and 6B. The arrows in the AFM image clarify the location of the DNA strands.

### DETAILED DESCRIPTION OF THE INVENTION

The present invention relates to a method for identifying a nucleotide in a nucleic acid including stretching a nucleic acid to an extended conformation, subjecting a nucleotide of the stretched nucleic acid to electron tunneling spectroscopy, and obtaining a current-voltage curve or a current derivative-voltage curve as a result of the stretching to provide a resonance signature of the nucleotide in the nucleic acid.

Suitable nucleic acid molecules for use in the present invention include double-stranded DNA (ds-DNA), single-stranded DNA (ss-DNA), DNA/RNA hybrids, and RNA, genomic or recombinant, biologically isolated or synthetic.

Suitable methods for stretching include, but are not limited to, molecular combing (Deng et al., “DNA-Templated Fabrication of 1D-Parallel and 2D-Crossed Metallic Nanowire Arrays,” Nano Lett., 3:1545-1548 (2003); Michalet et al., “Dynamic Molecular Combing: Stretching the Whole Human Genome for High-Resolution Studies,” Science, 277:1518-1523 (1997); Yokota et al., “A New Method for Straightening DNA Molecules for Optical Restriction Mapping,” Nucleic Acids Res., 25:1064-1170 (1997); Otobe et al., “Behavior of DNA Fibers Stretched by Precise Meniscus Motion Control,” Nucleic Acids Res., 29:e109 (2001), which are hereby incorporated by reference in their entirety) in which the motion of a droplet containing DNA strands on a flat surface is used to stretch the molecules, electrophoretic stretching (Germishuizen et al., “Selective Dielectrophoreticmanipulation of Surface-Immobilized DNA Molecules,” Nanotechnology, 14:896-902 (2003); Namasivayam et al., “Electrostretching DNA Molecules Using Polymer-Enhanced Media Within Microfabricated Devices,” Anal. Chem., 74:3378-3385 (2002); Kaji et al., “Molecular Stretching of Long DNA in Agarose Gel Using Alternating Current Electric Fields,” Biophys. J., 82:335-344 (2002), which are hereby incorporated by reference in their entirety) in which time-invariant or alternating electric fields are used to stretch DNA, transfer printing (Guan et al., “Generating Highly Ordered DNA Nanostrand Arrays,” Proc. Natl. Acad. Sci. USA, 102:18321-18325 (2005); Nakao et al., “Transfer-Printing of Highly Aligned DNA Nanowires,” J. Am. Chem. Soc., 125:7162-7163 (2003), which are hereby incorporated by reference in their entirety) in which the transfer of pre-aligned DNA samples is used to create DNA structures on a new surface, and hydrodynamic stretching (Perkins et al., “Relaxation of a Single DNA Molecule Observed by Optical Microscopy,” Science, 264:822-826 (1994); Ye et al., “Atomic Force Microscopy of DNA Molecules Stretched by Spin-Coating Technique,” Anal. Biochem., 281:21-25 (2000), which are hereby incorporated by reference in their entirety) in which controlled fluid flow is used to stretch the DNA molecules on a surface. These methods have been developed to orient DNA molecules on a solid support and can be used to create extended nucleic acids which are non-bundled and uncoiled.

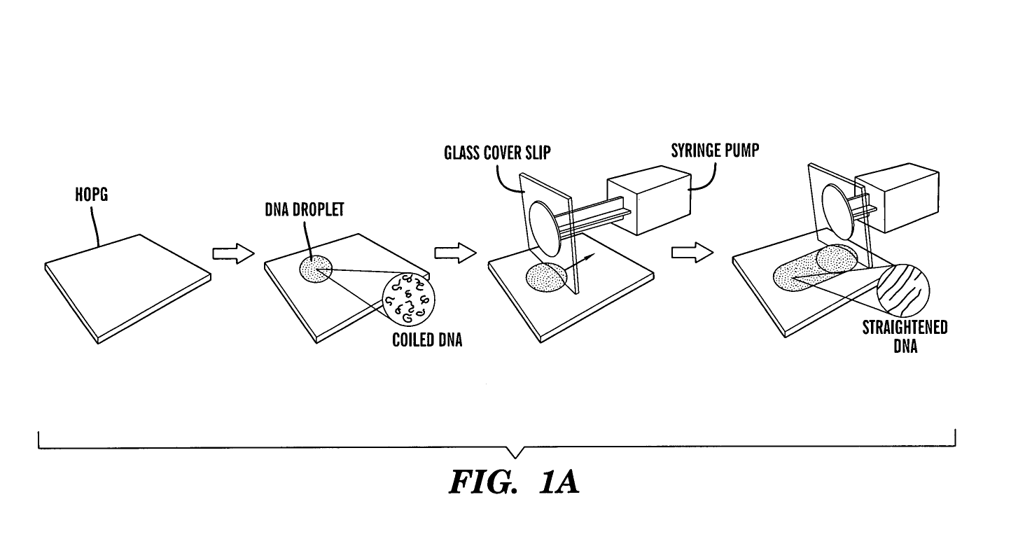

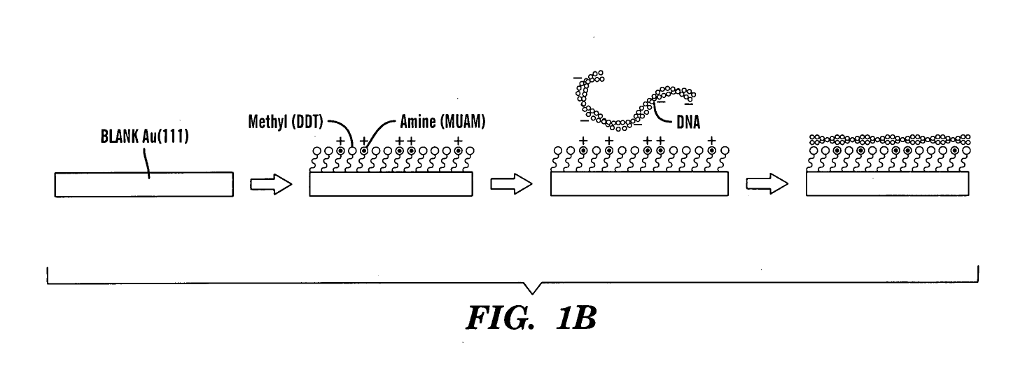

In a preferred embodiment of the present invention, the stretching is achieved by molecular combing. DNA molecular combing, first described by Bensimon et al. “Alignment and Sensitive Detection of DNA by a Moving Interface,” Science, 265:2096-2098 (1994), which is hereby incorporated by reference in its entirety, involves the stretching of individual DNA molecules or bundles of molecules by a receding meniscus between the substrate and a glass coverslip. Surface tension, acting perpendicular to the direction of motion of the meniscus, extends the DNA during movement. This procedure for stretching is shown schematically in FIGS. 1A-B.

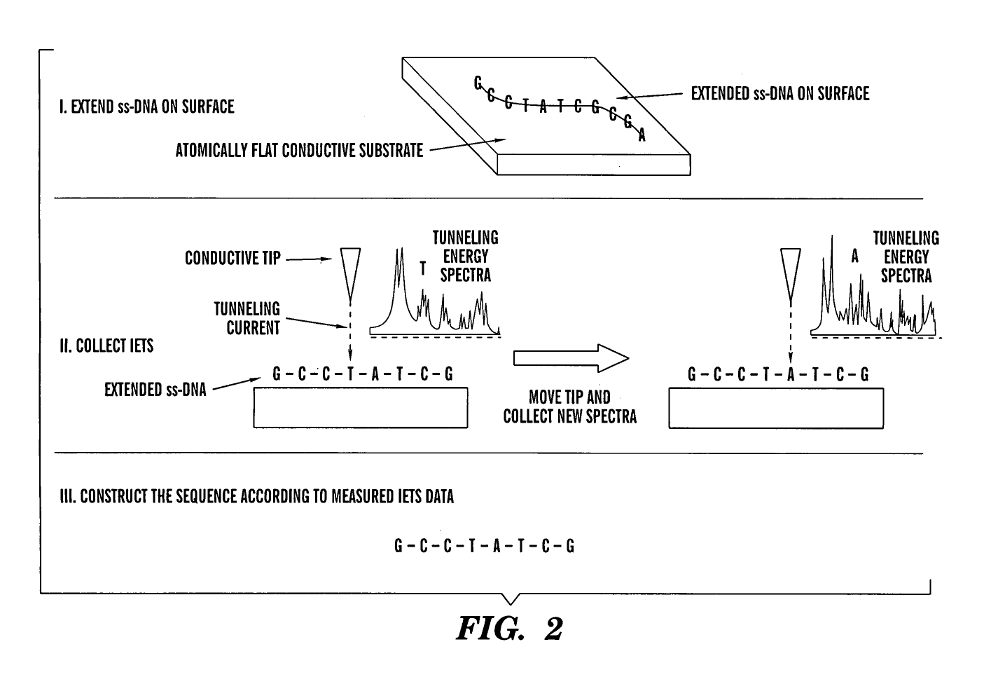

In one embodiment, the stretched nucleic acid is positioned on a surface of a first electrode. In one preferred embodiment, the nucleic acid is ds-DNA, wherein the ds-DNA helix is stretched on a surface (see FIG. 1B). In another preferred embodiment, the nucleic acid is ss-DNA fixed in a stretched conformation on the first electrode. This is shown, for example, in FIG. 2. In particular, FIG. 2 shows a first electrode, which is an atomically flat conductive substrate, having stretched ss-DNA positioned on its surface.

As shown in FIG. 2, suitable first electrodes in accordance with the present invention include flat, conductive substrates. These include, but are not limited to, a highly ordered pyrolytic graphite (“HOPG”) substrate, an atomically flat gold substrate, and an atomically flat copper substrate. HOPG and gold are preferred substrates because of their high conductivity, availability, and well-defined surface atomic structure.

In one preferred embodiment, at least a portion of the first electrode is treated under conditions effective to produce positively charged groups on the surface of the first electrode prior to stretching the nucleic acid (see FIG. 1B). These positively charged groups bind to the nucleic acid. In particular, in order to tune the strength of interaction between the nucleic acid strands and the substrates, positively charged groups, such as coordinating ions and self-assembled monolayers (“SAMs”) may be positioned on the surface of the first electrode. The choice of positively charged groups will be decided by the first electrode being used and can be determined by one of ordinary skill in the art. For example, for an HOPG substrate, treatment with MgCl₂ will produce positively charged groups on the surface of the HOPG substrate. For a gold substrate, treatment with mixed SAMs containing mercaptundecylamine and dodecanethiol, or other thiolates, will produce positively charged groups on the surface of the gold substrate. The concentration of the coordinating ion/SAM solution and the duration of exposure of the first electrode to the solution will determine the resident charge density on the surface of the first electrode.

In another embodiment of the present invention, at least a portion of the stretched nucleic acid is coated with a dielectric layer after it is positioned on the surface of the first electrode. A preferred dielectric layer is less than about 2 nm in thickness and can be deposited by methods known to those of ordinary skill in the art including, but not limited to, atomic layer deposition, chemical vapor deposition, sputtering, and physical vapor deposition. The dielectric layer helps retain the stretched nucleic acid in position on the surface of the first electrode, especially during movement of the first and/or second electrodes as described below, and allows the use of higher voltages when subjecting the stretched nucleic acid to electron tunneling spectroscopy. Suitable dielectric layers include, but are not limited to, aluminum oxide, silicon dioxide, and titanium dioxide.

In accordance with the present invention, a second electrode is positioned proximate to the stretched nucleic acid. Suitable second electrodes in accordance with the present invention include, but are not limited to, a scanning tunneling microscope tip, such as a Pt/Ir STM tip, a carbon nanotube, and a nanowire. This is shown, for example, in FIG. 2. In particular, FIG. 2 shows a conductive tip (i.e., second electrode) positioned proximate to the stretched nucleic acid.

A bias voltage is then applied to the first and second electrodes to produce a tunneling current effective to excite a resonant mode in the stretched nucleic acid (see FIG. 2). Accordingly, the nucleotide in the method of the present invention is subjected to electron tunneling spectroscopy (Stipe et al., “Single-Molecule Vibrational Spectroscopy and Microscopy,” Science, 280:1732-1735 (1998); Stipe et al., “A Variable-Temperature Scanning Tunneling Microscope Capable of Single-Molecule Vibrational Spectroscopy,” Review of Scientific Instruments, 70:137-143 (1999); Zhu et al., “Single Molecule DNA Sequencing with Inelastic Tunneling Spectroscopy STM”, Los Alamos Research Laboratory Research Highlights, pp. 83-84 (2006), which are hereby incorporated by reference in their entirety). Electron tunneling spectroscopy is used to identify unique spectroscopic signatures of each individual nucleotide. In one embodiment, the nucleotide of the stretched nucleic acid is subjected to inelastic electron tunneling spectroscopy. In another embodiment, the nucleotide of the stretched nucleic acid is subjected to elastic electron tunneling spectroscopy. For example, in inelastic electron tunneling spectroscopy, when a molecule is placed between two electrodes connected to a sufficient bias voltage, a tunneling current results (see FIG. 2). As the voltage increases, the energy of electrons tunneling through the molecules also increases until it reaches the point where the electrons have enough energy to excite a resonant mode in the molecule, allowing an increased electron transmission rate. This results in a current-voltage (I-V) curve for the electrodes that is kinked at points where new resonant modes are excited. These kinks appear as peaks in a second derivative representation of the I-V curve. The different chemical structure of each base in a nucleic acid results in a distinguished resonance signature in the I-V curves hence allowing for direct identification of the nucleotide molecules. The second derivative signal can be obtained from either a direct measurement with a lock-in amplifier or by mathematical differentiation of the measured I-V response. The detected signal may contain smaller contributions from the neighboring nucleotides. For sequencing of multiple nucleotides, after acquisition of the spectra at a first location, the first or second electrode is moved to a new location along the extended nucleic acid (e.g., either single-stranded or double-stranded) and the procedure is repeated. This is shown, for example, in FIG. 2, where the second electrode, a conductive tip, is moved to second location along the extended nucleic acid strand. The collection of the spectral data along the nucleic acid strands and the establishment of the spectra vs. location data allows for assignment of bases in the structure of nucleic acid.

It should be noted that the elastic electron tunneling spectra of the molecule can be utilized in the same fashion for sequencing. In this case, the first derivative current vs. voltage curve, or the conductance, will carry the relevant spectral information. The first derivative can be either measured directly using a lock-in amplifier or indirectly by mathematically differentiating the measured current vs. voltage behavior of the first electrode-molecule-second electrode junction. The main difference between the inelastic and elastic tunneling spectra is the energy transfer between the tunneling electron and the molecule. In the elastic case, unlike the inelastic case, the electron does not necessarily excite a vibronic mode of the molecule.

A suitable voltage for performing the method with inelastic electron tunneling spectroscopy is from about −0.5 V to about +0.5 V, preferably from about −0.3 V to about +0.3 V. A suitable voltage for performing the method with elastic electron tunneling spectroscopy is from about −10 V to about +10 V, preferably from about −7 V to about +7 V.

In one embodiment, the resonance signature is a first derivative electron tunneling spectrum of the nucleotide. In another embodiment, the resonance signature is a second derivative inelastic electron tunneling spectrum of the nucleotide. As described above, such second derivative inelastic electron tunneling spectra have peaks at resonant energy modes allowing for simple identification of nucleotide molecules.

The method of the present invention also includes comparing the resonance signature of the nucleotide to known nucleotide resonance signatures to identify the nucleotide. Known nucleotide resonance signatures include those of adenine, thymine, cytosine, guanine, uracil, and nucleotide analogues.

The present invention also relates to a method for sequencing a nucleic acid. The method includes stretching a nucleic acid to an extended conformation, the nucleic acid including a plurality of nucleotides, subjecting each nucleotide of the stretched nucleic acid to electron tunneling spectroscopy, and obtaining a current-voltage curve or current derivative-voltage curve as a result of said subjecting to provide a resonance signature of each nucleotide in the stretched nucleic acid.

In accordance with one embodiment of the present invention, the molecule may be located on the first electrode by performing a rough scan of the first electrode with the STM. In addition, the method of the present invention includes translating the first or second electrode to a position sufficient to measure the resonance signature of each nucleotide in the stretched nucleic acid (see FIG. 2). In particular, the nucleic acid molecule may be followed with a computer controlled electrode, such as an STM tip, to identify each nucleotide.

In yet another embodiment, multiple electrodes may be used to simultaneously identify multiple nucleotides in the stretched nucleic acid. Thus, for example, an array of STM tips may be used to analyze a nucleic acid.

The methods of the present invention may be carried out at any suitable temperature, including room temperature and cryogenic temperatures. In particular, IETS spectra are generally obtained at temperatures below 77 K and produce superior results at temperatures below 5 K. This is because at increased temperatures, peaks broaden, making them more difficult to visually distinguish. However, in accordance with the present invention, even at room temperature it is possible to identify differences between spectra even where no sharp peaks are visible.

### EXAMPLES

### Example 1

### DNA Molecule Stretching on a Graphite Surface

The procedure for stretching DNA molecules on a surface is shown schematically in FIG. 2. For extension on graphite, highly ordered pyrolytic graphite (“HOPG”) (SPI supplies, West Chester, Pa.) was cleaved using an adhesive tape and soaked in 10 mM MgCl₂ solution for 10 minutes prior to stretching the DNA molecules. The MgCl₂ binds to the freshly-cleaved HOPG and promotes adhesion to the DNA molecules. The concentration of the MgCl₂ solution and the duration of exposure of the HOPG to it directly determined the resident charge density on the surface of the substrate (Liu et al., “Ionic Effect on Combing of Single DNA Molecules and Observation of Their Force-Induced Melting by Fluorescence Microscopy,” J. Chem. Phys., 121:4302-4309 (2004), which is hereby incorporated by reference in its entirety). These charges interact with DNA strands and affect their motion along the surface of HOPG. The graphite substrate was then rinsed with deionized water and dried in a flow of air. Five microliters of non-methylated λ-phage DNA (48 kbp; New England Biolabs, Ipswich, Mass.) solution (5 μg/mL; Tris-EDTA buffer, pH 7.8) was dispensed on one edge of the HOPG surface. The droplet was then dragged at the rate of 0.05 mm/sec employing a syringe pump (New Era Syringe Pumps, Wantagh, N.Y.) with a 18 mm×18 mm glass cover slip which formed a 90° angle with the surface of HOPG. The substrate was then rinsed with deionized water and air dried before imaging with AFM and STM. The λ phage DNA was ds-DNA and for single strand experiments it was disrupted to ss-DNA by heating at 95° C. for 5 minutes in 10 mM Tris, 0.1 mM EDTA buffer (TE buffer) at pH 7.8. The procedure was followed for more than ten different substrates to confirm its reproducibility.

### Example 2

### DNA Molecule Stretching on a Gold Surface

The extension of DNA on a gold surface required close control over the surface charge density. This density was controlled on gold by forming mixed SAMs of neutral and positively charged molecules at pre-determined ratios. In these experiments, the mixed SAMs containing mercaptundecylamine and dodecanethiol (in mole ratios, 0:1; 0.001:0.999; 0.01:0.99; 0.1; 0.9; and 1:0:: mercaptoundecylamine:dodecanethiol) were prepared on Au(111) substrates with atomically flat terraces (Agilent Technologies AFM, Phoenix, Ariz.) from a solution of both compounds in ethanol. The substrates were rinsed copiously using ethanol and dried in a vacuum dessicator. Non-methylated λ-phage DNA (48 kbp; New England Biolabs, Ipswich, Mass.) was stretched using a syringe pump (New Era Syringe Pumps, Wantagh, N.Y.) to draw a drop of λ-phage DNA (5 μL, 2.5 μg/mL; Tris-EDTA buffer, pH 7.8) over the mixed SAM on Au(111). The rate of withdrawal was 1 mL/min. Each experiment was repeated at least five times and was found to be highly reproducible.

### Example 3

### Imaging of Extended DNA

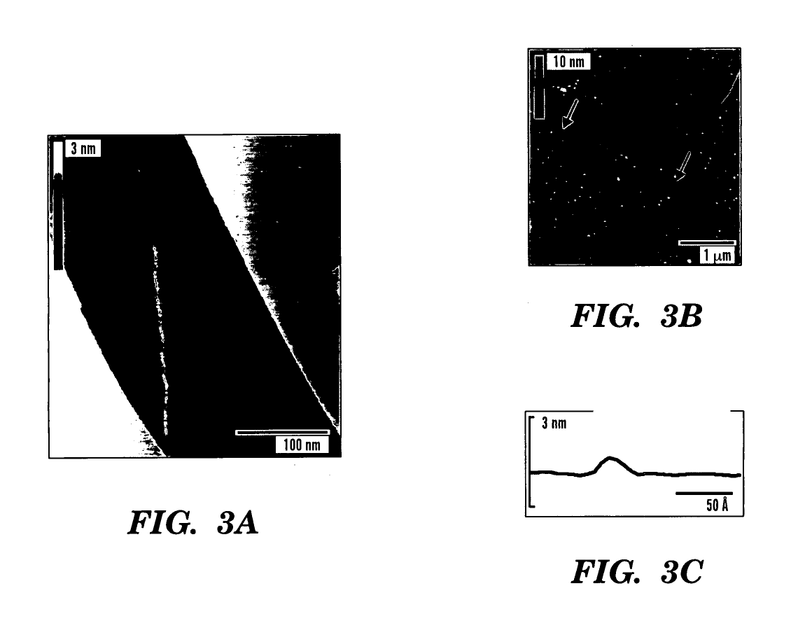

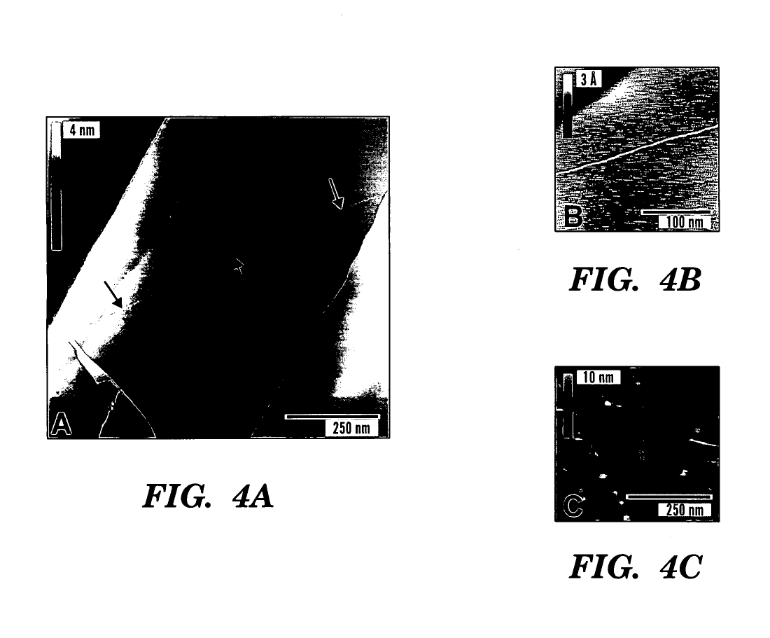

The extended λ-phage DNA molecules of Examples 1 and 2 were imaged employing tapping-mode AFM (Dimension 3100 AFM, Veeco, Woodbury, N.Y.) or STM (Agilent, Phoenix, Ariz.). The AFM data was processed using a built-in flattening algorithm and a section analysis of the stretched molecules of DNA was obtained. The stretched λ-phage DNA molecules were also characterized by room temperature STM (Agilent, Phoenix, Ariz.). The STM data was processed using a built-in flattening algorithm. In order to optimize the procedure of molecular combing and obtain the parameters needed for efficient combing of DNA, the λ phage ds-DNA was used and later the protocol was extended to comb ss-DNA in order to minimize the complications caused by the “sticky” nature of the ss-DNA. The AFM and STM images of λ phage ds-DNA combed on HOPG are shown in FIG. 3. Soaking HOPG in 10 mM MgCl₂ left the surface with sufficient positively charged groups to enable the adherence of the negatively charged phosphodiester backbone of DNA. The ss-DNA was maintained in a low ionic strength TE buffer solution lacking multivalent cations; this reduced the electrostatic screening of negative charges on the DNA backbone and increased intrastrand electrostatic repulsion, making intramolecular base-pairing less favorable in ss-DNA. The corresponding images are shown in FIG. 4, verifying the effectiveness of the molecular combing method.

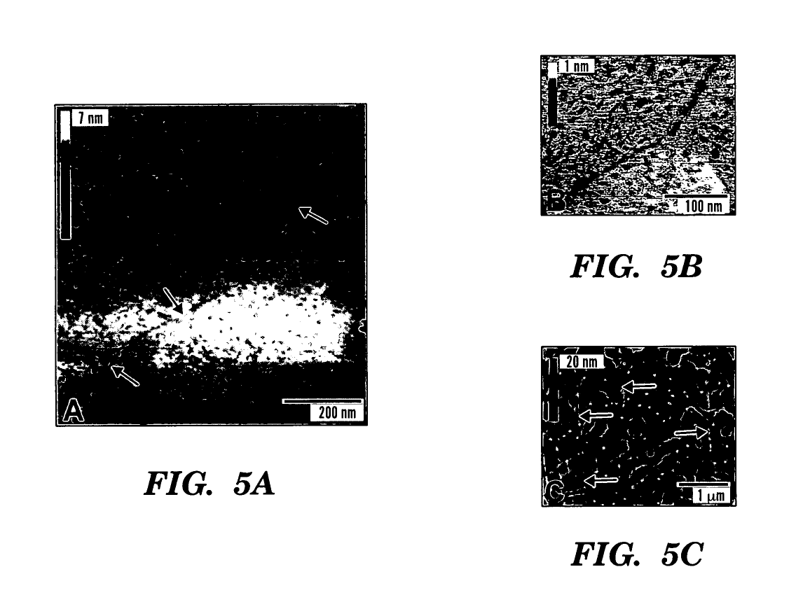

Mixed SAMs of 11-mercaptoundecylamine and dodecanethiol control the concentration of positively charged amine groups on the gold surface. This mixture of alkanethiols containing methyl and amine groups was used to tune the interaction between the negative backbone of DNA and the positive amine groups in the mixed SAM on the substrate; the methyl groups were expected to interact weakly with molecules of DNA. It was observed that high concentrations of amine groups in mixed SAMs decreased the ability of ds-DNA to extend as individual molecules on a gold substrate; for SAMs containing 100 mol % amine groups, ds-DNA formed aggregates or networks of molecules. Lower concentrations of amine groups (0.1-10 mol %) and hence weaker surface-DNA attraction provided the proper conditions for extending ds-DNA. It was observed also that ds-DNA interacts efficiently with a SAM containing only methyl groups to produce extended molecules; however, these samples could not be used for STM imaging since the force holding down the molecule to the surface during sweeping the tip was not large enough to prevent the molecule from moving with the scanning probe. The representative AFM and STM images of ds-DNA extended on Au(111) with SAM containing 1 mol % amine groups are shown in FIG. 5.

In the STM image, the contrast of the single molecule is inverted (the molecule is visible as a dark line or a depression on the surface). This phenomenon has been observed in other STM measurements of DNA molecules (Kawai, “Self-Assembly, Manipulation, and Discrimination of DNA Molecules by Scanning Tunneling Microscope (STM) on Solid Surfaces,” Ann. N.Y. Acad. Sci., 852:230-242 (1998), which is hereby incorporated by reference in its entirety) and is related to either the buffer species co-adsorbed around the DNA molecules or the hybridization effects between the DNA and the underlying metal.

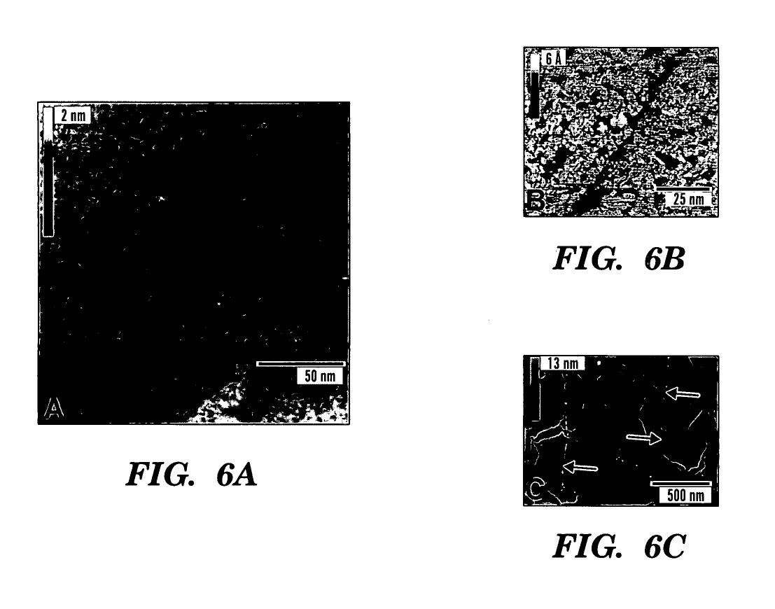

Similar results were observed with ss-DNA, where it formed aggregates on SAM containing 100 mol % amine groups and extended well on SAMs with lower concentration of amine groups (0.1-10 mol %) and SAMs containing only methyl groups. The representative images of ss-DNA extended on Au(111) with SAM containing 1 mol % amine groups are shown in FIG. 6. The average number of extended strands and their spacing can be controlled by varying the initial concentration of the DNA solution. A systematic study was also carried out to determine the affect of meniscus withdrawal speed on extending DNA. The DNA molecules were withdrawn at five different speeds, 0.005 mm/sec, 0.01 mm/sec, 0.05 mm/sec, 0.1 mm/sec and 0.5 mm/sec. The slower the withdrawal speed, the better the DNA extension, confirmed by AFM imaging of all the samples.

Thus, a simple and efficient technique for extending DNA on conductive surfaces for high-resolution scanning probe studies is presented. This approach for generating surface-bound, extended DNA molecules is reproducible and inexpensive. A key component of the method is engineering the density of surface changes interacting with the DNA backbone. By using mixed SAMs on a gold substrate, it has been demonstrated that this charge density can be controlled and utilized to extend viral DNA strands on conductive surfaces. This protocol for extending viral ss-DNA can produce a platform for sequencing its individual bases employing STM and on-spot spectroscopy.

### Example 4

### IETS Setup

To perform IETS measurements with an STM tip, a commercially available STM (Agilent 4500 AFM/SPM, Model 300 STM scanner, Phoenix, Ariz.) was modified. All first and second derivative signals were measured directly using a lock-in amplifier (Stanford Research Model 830, Sunnywale, Calif.) tuned to the first and second harmonic of a sinusoidal reference signal. A bias voltage signal was provided by a data acquisition card (National Instruments PCI-6281, Austin, Tex.). The bias signal was combined with a reference sine wave (750 Hz, 40 mV amplitude) using OP-27 operational amplifiers.

The STM was wired normally; however, the sample bias signal was relayed in such a way that the sample bias provided by the microscope could be replaced by the aforementioned sine wave-modified signal necessary for conducting IETS measurements. The Agilent STM scanner contains an internal 10⁹ transimpedance amplifier which amplifies the tunneling current and converts it to a voltage signal. This signal (which is also used for STM feedback) was connected to the input of the lock-in amplifier.

To conduct IETS measurements, the STM was used to image a sample of interest and position the STM tip at a desired location. The STM feedback was then turned off, switched to the custom sample bias, and the output from the lock-in amplifier was measured using a different channel of the same data acquisition card. To ensure reliable data, the integration time on the lock-in amplifier was set to 1 second and the rolloff was set to 24 dB/oct. Because of this, the first several seconds of output from the lock-in were unreliable and had to be discarded. A typical measurement included data 19-20 seconds after initially applying the bias. After the measurement was collected, the feedback was turned on again to reset the tip to its setpoint current of 50 pA at 300 mV bias. Background noise and instrumentation offset error was identified by running an IETS measurement with no AC component. The results of this experiment indicated the background error to be negligible.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1 A method for identifying a nucleotide in a nucleic acid comprising:
stretching a nucleic acid to an extended conformation;
subjecting a nucleotide of the stretched nucleic acid to electron tunneling spectroscopy; and
obtaining a current-voltage curve or a current derivative-voltage curve as a result of said subjecting to provide a resonance signature of the nucleotide in the nucleic acid.

2. The method according to claim 1, wherein said subjecting comprises:
positioning the stretched nucleic acid on a surface of a first electrode;
positioning a second electrode proximate to the stretched nucleic acid; and
applying a bias voltage to the first and second electrodes to produce a tunneling current effective to excite a resonant mode in the stretched nucleic acid.

3. The method according to claim 2 further comprising:
treating the first electrode under conditions effective to produce positively charged groups on the surface of the first electrode prior to said stretching, wherein said positively charged groups bind to the nucleic acid.

4. The method according to claim 2 further comprising:
coating at least a portion of the stretched nucleic acid with a dielectric layer prior to said positioning the second electrode.

5. The method according to claim 2, wherein the first electrode is a flat highly ordered pyrolytic graphite substrate, an atomically flat gold substrate, or an atomically flat copper substrate.

6. The method according to claim 2, wherein the second electrode is a scanning tunneling microscope tip, a carbon nanotube, or a nanowire.

7. The method according to claim 1 further comprising:
comparing the resonance signature of the nucleotide to known nucleotide resonance signatures to identify the nucleotide.

8. The method according to claim 7, wherein the known nucleotide resonance signatures are of adenine, thymine, cytosine, guanine, uracil, and nucleotide analogues.

9. The method according to claim 1, wherein said stretching is selected from the group consisting of molecular combing, electrophoretic stretching, transfer printing, and hydrodynamic stretching.

10. The method according to claim 9, wherein said stretching comprises molecular combing.

11. The method according to claim 1, wherein the resonance signature is a first derivative electron tunneling current spectrum of the nucleotide.

12. The method according to claim 1, wherein the resonance signature is a second derivative inelastic electron tunneling spectrum of the nucleotide.

13. A method for sequencing a nucleic acid comprising:
stretching a nucleic acid to an extended conformation, the nucleic acid comprising a plurality of nucleotides;
subjecting each nucleotide of the stretched nucleic acid to electron tunneling spectroscopy; and
obtaining a current-voltage curve or a current derivative-voltage curve as a result of said subjecting to provide a resonance signature of each nucleotide in the stretched nucleic acid.

14. The method according to claim 13, wherein said subjecting comprises:
positioning the stretched nucleic acid on a surface of a first electrode;
positioning a second electrode proximate to the stretched nucleic acid; and
applying a bias voltage to the first and second electrodes to produce a tunneling current effective to excite a resonant mode in the stretched nucleic acid.

15. The method according to claim 14 further comprising:
treating the first electrode under conditions effective to produce positively charged groups on the surface of the first electrode prior to said stretching, wherein said positively charged groups bind to the nucleic acid.

16. The method according to claim 14 further comprising:
coating at least a portion of the stretched nucleic acid with a dielectric layer prior to said positioning the second electrode.

17. The method according to claim 14 further comprising:
translating the first or second electrode to a position sufficient to measure the resonance signature of each nucleotide in the stretched nucleic acid.

18. The method according to claim 14, wherein the first electrode is a flat highly ordered pyrolytic graphite substrate, an atomically flat gold substrate, or an atomically flat copper substrate.

19. The method according to claim 14, wherein the second electrode is a scanning tunneling microscope tip, a carbon nanotube, or a nanowire.

20. The method according to claim 13 further comprising:
comparing the resonance signature of each nucleotide to known nucleotide resonance signatures to identify each nucleotide.

21. The method according to claim 20, wherein the known nucleotide resonance signatures are of adenine, thymine, cytosine, guanine, uracil, and nucleotide analogues.

22. The method according to claim 13, wherein said stretching is selected from the group consisting of molecular combing, electrophoretic stretching, transfer printing, and hydrodynamic stretching.

23. The method according to claim 22, wherein said stretching comprises molecular combing.

24. The method according to claim 13, wherein the resonance signature is a first derivative electron tunneling current spectrum of the nucleotide.

25. The method according to claim 13, wherein the resonance signature is a second derivative inelastic electron tunneling spectrum of the nucleotide.
